(19) United States
(12) Patent Application Publication
(10) Pub. No.: US 2012/0085712 A1
(43) Pub. Date: Apr. 12, 2012

(54) Filter apparatus and method

(76) Inventor: Joseph Anthony Moss, Pensacola, FL (US)

(21) Appl. No.: 12/924,860

(22) Filed: Oct. 6, 2010

(51) Int. Cl. B01D 29/50; B01D 29/56; B01D 37/00

(52) U.S. Cl. 210/789; 210/335; 210/806; 210/295; 210/339

(57) ABSTRACT

A filter apparatus includes a first sample material section. A second filter section, with a second filter, is connected with the first sample material section and a third filter section, with a third filter, is connected with the second filter section. A retaining vessel is provided within which the first sample material section, the second filter section and the third filter section fit and a lid is included that is conformed to connect with the retaining vessel such that the lid seals the retaining vessel when connected.

### FIELD OF THE INVENTION

This invention relates to a filter apparatus and method. In particular, in accordance with one embodiment, the invention relates to a filter apparatus including a first sample material section. A second filter section, with a second filter, is connected with the first sample material section and a third filter section, with a third filter, is connected with the second filter section. A retaining vessel is provided within which the first sample material section, the second filter section and the third filter section fit and a lid is included that is conformed to connect with the retaining vessel such that the lid seals the retaining vessel when connected.

### BACKGROUND OF THE INVENTION

A difficulty arises in the field of public health when it becomes necessary to test water for contaminants. By way of example only and not by way of limitation, pathogens in water are a serious problem. Cryptosporidium and Giardia are intestinal entero-pathogenic parasites of humans and animals, producing asymptomatic to severe intestinal infections, depending on the virulence of the parasite involved and the health of the host. Contemporary prior art procedures entail the capturing and detection of entero-pathogenic organisms, specifically Cryptosporidium and Giardia according to a required method. To date, the U.S. Environmental Protection Agency Enhanced Surface Water Treatment Rule (LT2 rule) mandates the use of Method 1623 for monitoring source waters and drinking water. The method consists of filtration, concentration, immunomagnetic separation (IMS), fluorescent antibody and 4′, 6′-diamidino-2-phylindole (DAPI) counter staining, and microscopic detection and enumeration. The standard method specifies collection of samples onto Environcheck filters (Pall Gelman Laboratory, Ann Arbor, Mich.) or Idexx filters (IDEXX Laboratories, Inc., Westbrook, Me.) followed by back flushing, concentration through centrifugation and then separation of target organisms from non-target organisms through use of immune-magnetic beads (i.e. Dynal Biotech, Oslo, Norway). The use of microscopic techniques as the detection method is hampered by being skilled labor-intensive and time consuming (LeChevallier et al. 1995), and also by its inability to distinguish between human and animal pathogenic Cryptosporidium and Giardia species. This technique may also incur problems with false positives and either low and/or variable rates of recovery. These prior art methodologies are expensive, time consuming, require significant training to accomplish, and the multiple steps involved reduce target cyst recovery. In short, the current standard method is cost prohibitive for routine use.

Molecular techniques have been developed to amend for problems involved with microscopy but has continued the use of the IMS technique with various molecular approaches (IMS-PCR); including PCR with sequencing and nested-PCR with sequencing and use of molecular probes. PCR-based methodologies also hold promise for differentiating human-enteric from non-human-enteric pathogens (feline, canis, etc) and for tracking contamination sources in water. However, environmental waters, such as surface water and sewage outfalls, are complex matrices known to contain numerous organic and inorganic substances with the potential to limit cyst recovery and inhibit PCR. An inverse relation between turbidity and % recovery, especially in instances of high turbidity, has been reported.

Thus, serious problems remain in the field and there is a need in the art for a reusable device to be used in conjunction with a simpler, faster, and less expensive method for concentrating and isolating the cysts of pathogens from water samples.

Further, there is a need in the art for an apparatus and method that eliminates extraneous material from the sample such that follow on tests are more accurate and reliable. It, therefore, is an object of the invention to provide a filter apparatus and method that is easy to use, that is reusable, that enables the collection of captured material that is free of extraneous material and that is adjustable for various sizes of target material.

### SUMMARY OF THE INVENTION

Accordingly, the filter apparatus of the present invention, according to one embodiment includes a first sample material section. A second filter section, with a second filter, is connected with the first sample material section. A third filter section, with a third filter, is connected with the second filter section. A retaining vessel is provided within which the first sample material section, the second filter section and the third filter section fit and a lid is conformed to connect with the retaining vessel such that the lid seals the retaining vessel when connected.

As used herein the term “filter” is given its common meaning of any device used to screen or separate one material from another material. In this regard, filters include barriers to material and passages through which material can pass so long as the material is smaller than the passage. Thus, filters are found in a variety of “sizes” in that they are built to screen out material larger than the particular size of the filter.

In a further aspect, the lid is a double sealing lid conformed to connect with the first sample material section and the retaining vessel. In one aspect, the first sample material section is tapered. In another aspect, a first filter is provided for temporarily holding sample material. In another aspect, the first filter is a onetime use filter and in another aspect the one time use filter is dissolvable.

In a further aspect, the second filter is one size of filter and the third filter is another size of filter. In another aspect, the second filter is a larger size of filter than the third filter.

In another aspect, the retaining vessel includes an interior support. In one aspect, the third filter section rests on and is supported by the interior support. hi another aspect, the retaining vessel includes a collection basin.

According to another embodiment, a cyst filter apparatus includes a tapered first sample material section. A second filter section, with a second filter of one size, is connected with the first sample material section. A third filter section, with a third filter of a size different than the second filter, is connected with the second filter section. A retaining vessel is provided within which the first sample material section, the second filter section and the third filter section fit and a lid is conformed to connect with the retaining vessel such that the lid seals the retaining vessel when connected.

In one aspect, the invention includes a one time use dissolvable first filter for holding sample material in the first sample material section. In another aspect, the second filter is a larger size of filter than the third filter. In another aspect, the retaining vessel includes an interior support. In a further aspect, the third filter section rests on and is supported by the interior support. In another aspect, the lid is a double sealing lid conformed to connect with the first sample material section and the retaining vessel.

According to another embodiment, a filter method includes the steps of: collecting a sample; providing a first sample material section, a second filter section, with a second filter, connected with the first sample material section, a third filter section, with a third filter, connected with the second filter section, a retaining vessel within which the first sample material section, the second filter section and the third filter section fit and a lid conformed to connect with the retaining vessel such that the lid seals the retaining vessel when connected; placing the sample in the first sample material section; placing the first sample material section, the second filter section and the third filter section in the retaining vessel; adding elution fluid to the sample; and connecting the lid with the retaining vessel.

In another aspect, the method further includes the step of agitating the retaining vessel after connecting the lid with the retaining vessel. In one aspect, the method further includes the step of placing the retaining vessel in a centrifuge after agitating the retaining vessel.

In another aspect, the step of placing a sample in the first sample material section includes locating sample material on a dissolvable first filter in the first sample material section. In another aspect, the method further includes adjusting the sizes of the second filter and the third filter so as to trap various sizes of material from the sample.

### DESCRIPTION OF THE DRAWINGS

Other objects, features and advantages of the present invention will become more fully apparent from the following detailed description of the preferred embodiment, the appended claims and the accompanying drawings in which:

FIG. 1 is an exploded view of the filter apparatus according to one embodiment with FIG. 1A showing the lid and three filter sections and FIG. 1B showing the retaining vessel; and

FIG. 2 is an exploded view of another filter system for use in the filter apparatus of FIGS. 1A and 1B.

### DETAILED DESCRIPTION OF THE INVENTION

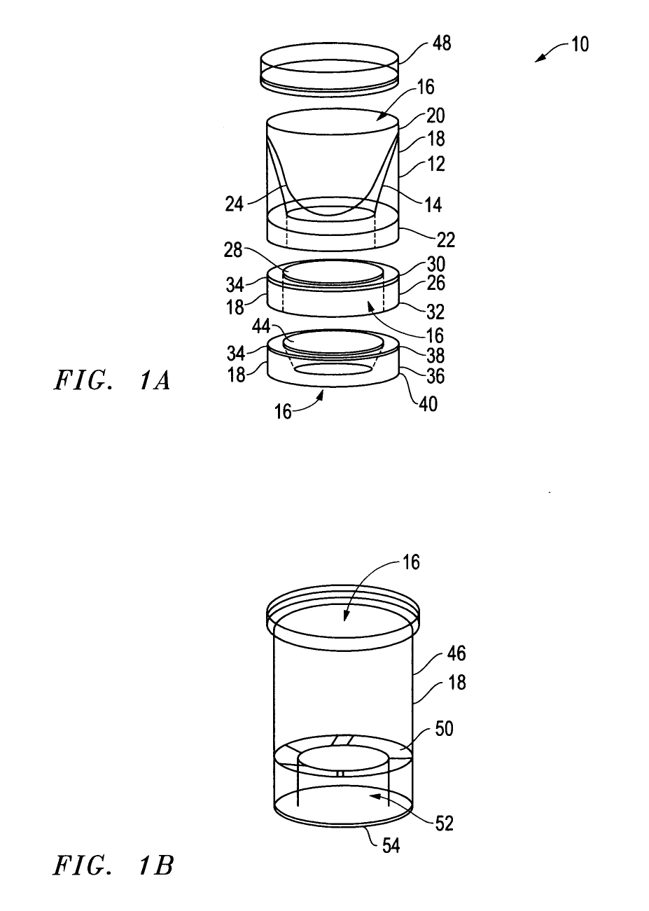

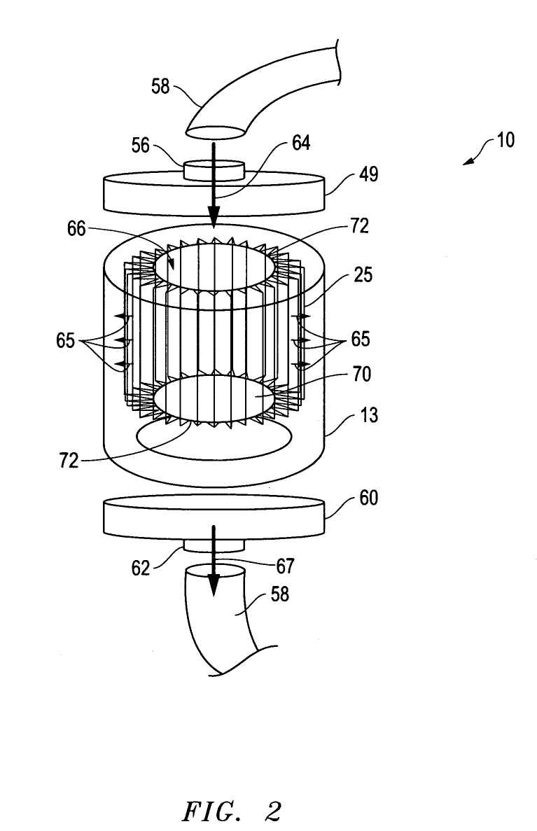

The preferred embodiment of the present invention is illustrated by way of example in FIGS. 1A, 1B and 2. With specific reference to the figures, the filter apparatus 10, according to one embodiment of the invention, includes a first sample material section 12. Preferably, as shown in FIG. 1A, first sample material section 12 includes a tapered section 14 in the interior 16 of first sample material section 12. That is, first sample material section 12 includes an outside 18, an anterior end 20 and a posterior end 22. The first sample material section 12 is open from anterior end 20 to posterior end 22. Tapered section 14 is wider at the anterior end 20 than at the posterior end 22 as shown. Tapered section 14 thus provides support for a first filter 24 and first filter 24 generally conforms its shape to the tapered section 14 when placed into interior 16.

FIG. 1A also shows second filter section 26. Second filter section 26 includes an interior 16, an outside 18 just as first sample material section 12. Second filter section 26 does not include tapered section 14 but does include a second filter 28. Second filter 28 is connected across the opening created by the interior 16 of second filter section 26. That is, second filter 28 covers the interior 16 as shown. Second filter section 26 includes an anterior end 30 and a posterior end 32. Anterior end 30 includes threads 34 designed to cooperate with threads 34 (not shown) in the posterior end 22 of first sample material section 12 such that the two sections are held tightly together. Again, as illustrated, in this manner second filter 28, when the first sample material section 12 and the second filter section 26 are connected with each other as just described, is held in position below first filter 24, if present, such that any material passing from first filter 24 must pass to second filter 28, as will be described more fully hereafter.

Still referring to FIG. 1A, any material passing from second filter 28 passes from second filter section 26 to third filter section 36. Third filter section 36 is similar to second filter section 26 in that it also includes threads 34 in the anterior end 38 of third section 36. Threads 34 of third section 36 cooperate with threads (not shown) in the posterior end 32 of second filter section 26 such that when connected the two sections are held firmly together. Obviously, any connection mechanism other than threads now known, such as clamps or screws, for example only, or hereafter developed that serve the function and purpose of threads 34 is suitable.

Third filter section 36 includes third filter 44. Third filter section 36 includes an outside 18 and an interior 16 as shown and third filter 44 is located across the interior 16. Preferably, third filter 44 is located near the anterior end 38 of third filter section 36 as shown. Thus, when third filter section 36 is connected with second filter section 26, by threads 34 for example, third filter 44 receives any material passing from second filter 28 and second filter section 26.

Referring now to FIG. 1B, filter apparatus 10 includes retaining vessel 46. Retaining vessel 46 is conformed in dimension to receive first sample material section 12, second filter section 26 and third filter section 36 when connected together as discussed above. Lid 48 is conformed to connect with retaining vessel 46 and to seal retaining vessel 46 when connected. Cooperative threads (not shown) in lid 48 and retaining vessel 46 may be used to join them together or any other useful device. In a preferred embodiment, lid 48 is a double sealing lid that connects with the anterior end 20 of first sample material section 12. Once connected, all three connections are sealed by lid 48 and all three sections may be manipulated to be inserted into retaining vessel 46. Thereafter, lid 48 is connected with retaining vessel 46, by cooperation of threads 34 for example only. This double sealing feature ensures that the entire device is vapor tight and securely held in place such that the sections do not move.

According to one embodiment, a support ledge 50 is provided on the interior 16. When present, the posterior end 40 of third filter section 36 rest on and is supported by interior support ledge 50.

Also preferably, retaining vessel 46 includes a collection basin 52 below support ledge 50. Retaining vessel 46 includes a sealed base 54 so that any material passing through third filter 44 into the interior 16 of retaining vessel 46 is captured within collection basin 52.

By way of further disclosure, an important feature of the invention includes a first filter 24 that is a one time use filter. That is, it is a throw away disposable filter that is used to catch or retain the subject sample of material. Thus the first filter 24 may be brought to the filter apparatus 10 from wherever the sample was obtained and then be inserted into the interior 16 of first sample material section 12. When wet, first filter 24 conforms to the shape of the interior 16 and, preferably, to tapered section 14.

Applicant has determined that a significant preferred embodiment includes the use of one time first filters 24 that are dissolvable. That is, Applicant has found that using a first filter 24 that dissolves in the presence of an elution fluid, such as acetone, for example only, has many advantageous results. One advantage is that the use of the elution fluid dissolves the first filter 24 such that first sample material section 12 is ready to receive another one without having to handle the prior first filter 24. A primary advantage of the dissolvable first filter 24, though, is that the elution fluid, such as acetone, also dissolves extraneous matter in a sample. The removal of this extraneous matter, Applicant has found, enhances the results obtained in follow on tests of any material captured by filter apparatus 10. The dissolved material and elution fluid passes through the filter apparatus 10 to the collection basin 52 in retaining vessel 46 from which it can be disposed. It should be understood that sample material may be placed directly into first sample material section 12 without a filter. Thus, if a sample has been collected on something the user does not wish to insert into first sample material section, or for whatever reason, sample material can simply be placed into the first sample material section directly.

By way of further explanation, second filter 28 and third filter 44 preferably are made of material that is impervious to elution fluids and that are usable time and time again. Applicant has found that stainless steel mesh membranes or screens are suitable for the purposes of the invention. Obviously, any such other filter material now known or hereafter developed may be used as well. Importantly, second filter 28 and third filter 44 while designed to be used again and again may be removed and replaced as desired. That is, in use, second filter 28 has a filter “size” or a mesh that is larger than the size of the specimen that is sought to be obtained by use of the filter apparatus 10. Second filter 28 thus passes elution fluid and dissolved extraneous material and anything smaller than the size of the mesh selected for second filter 28. Anything larger than that is retained by second filter 28 and does not pass.

Thereafter, third filter 44 preferably is of a size that is just smaller than the size of the specimen that is sought. In this manner, elution fluid and dissolved extraneous material and any material smaller than the size of the mesh of third filter 44 passes through third filter 44. Anything larger than the size of the mesh of third filter 44 is captured on top of third filter 44. By adjusting the size of second filter 28 and third filter 44 a user is enabled to capture any desired size of specimen with a single filter apparatus 10. This is a significant advantage over the prior art of limited, expensive, specialized filter systems known in the art.

Referring now to FIG. 2, another embodiment of the invention is shown in relation to a modified first sample material section 13 and a modified first filter 25. According to this aspect of the invention, modified first sample material section 13 includes a lid 49 which is similar to lid 48 but includes an inlet 56. Inlet 56 is provided to which tubing 58 may be removably attached. Inlet 56 may include a cap, not shown, to close inlet 56 when tubing 58 is not attached.

Modified first sample material section 13 also includes a bottom 60 with an outlet 62. Bottom 60 seals modified first sample material section 13. Outlet 62 operates as does inlet 56 to provide a connection for tubing 58 when desired. Outlet 62 may include a cap, not shown, to close outlet 62 when tubing 58 is not attached.

Still referring to FIG. 2, modified first filter 25, rather than a flat, coffee filter like filter shown in FIG. 1A, is a pleated, cylindrically shaped, for example only, filter in which fluid enters the modified first filter 25 through inlet 56 in the direction of direction arrow 64 into the center 66 of modified first filter 25. From there the fluid passes to the outside 68 of filter 25 in the direction of direction arrows 65. Filter 25 includes a filter bottom 70. Filter bottom 70 may be a filter that is the same as filter 25 or may be impervious. If it is impervious, it ensures that all the fluid passes from the center 66 to the outside 68 of modified first filter 25. From there fluid passes out of the modified first sample material section 13 by way of outlet 62 in the direction of direction arrow 67 to tubing 58 if present. If tubing 58 is not present, a cap, not shown, may be placed over outlet 62 so as to retain the fluid within modified first sample material section 13.

Modified first filter 25 may also include structural support such as a metal wire 72 at the top and bottom of filter 25. Filter 25 may even be encased in a wire mesh, not shown. In any event, modified first filter 25 is conformed to fit within modified first sample material section 13 and in conjunction with modified lid 49 and bottom 60 such that fluid can only flow into the center 66 of modified first filter 25 and then out through the filter 25 to the outside 68 of filter 25. That is, the modified first filter 25 fits so securely within modified first sample material section 13 that fluid can not pass through modified first sample material section 13 without passing through modified first filter 25. Instead, fluid passes to the outside 68 and is contained within modified first sample material section 13. From there, the modified lid 25 and the bottom 60 are removed and modified first sample material section 13 is connected with second filter section 26 and third filter section 36 as described above. If not already drained off through outlet 62, any filtered fluid in modified first sample material section 13 flows through second section 26 and third filter section 36. As above, modified first filter 25 is dissolvable and the methodology described above is followed with and applies to the use of modified first filter 25 as well.

By way of continued explanation, Applicants' filter apparatus 10 is a new reusable device to be used in conjunction with a simpler, faster, and less expensive method for concentrating and isolating cysts, preferably but for example only and not by way of limitation, of pathogens from water samples. Once the sample and elution fluid have been added and sealed within the retaining vessel, the Applicant has utilized centrifugation for the simultaneous separation of cysts from larger acetone non-soluble materials, by means of the combination of second filter 28 and third filter 44 as described, from acetone soluble materials. Again, Applicant has found that these extraneous materials may limit DNA extraction efficiencies and may inhibit PCR reactions, reducing detection sensitivities. Applicant has found that a properly sized retaining vessel 46 will fit into a Sorvall® GSA centrifuge rotor as made by Thermo Fisher Scientific Inc.

Again, filter apparatus 10 as shown in the figures (see particularly FIG. 1A) is divided into three different sections housed within a retaining vessel 46 (FIG. 1B). The filter apparatus 10 has been machined out of nylon stock, but any solvent resistant material will work. The filter apparatus 10 holds, as discussed, stainless steel screens as filter supports and pre-screening filters of variable mesh sizes depending on the application. The second filter 28 is a pre-screen filter to remove large materials but allow cysts to pass. The third filter 44 (track etched 2 micron membrane filters have been used) catches the target cysts and allows smaller and dissolved materials to pass. The third filter 44 is then transferred to a bead beater tube or similar DNA extraction protocol where the captured cysts are analyzed in follow on tests as is known.

Preferably, first sample material section 12 consists of a tapered chamber 14 (toward posterior end 22). Second filter section 26 secures tightly to the posterior end 22 of first section 12. A water tight gasket may be included, for example only to ensure that no sample or fluids escape from between the sections. The anterior end 30 of second filter section 26 consists, preferably, of an inset in which rests a pre-fabricated, machined, stainless steel mesh sieve that forms second filter 28.

Third filter section 36 preferably secures tightly, as above, to the posterior end 32 of second filter section 26. The anterior end 38 of third filter section 36 includes an inset in which rests a pre-fabricated, machined steel mesh sieve that forms third filter 44.

The filter method of the present invention proceeds as follows. Sample water is collected on either 47 mm or 142 mm filters (mixed esterase cellulosic). The collection filter(s) is the first filter 24 and, when present, it is placed in the top chamber of the device, first sample material section 12. Otherwise, sample material is simply placed directly into first sample material section. Thereafter the three connected filter sections are placed within the retaining vessel 46 and an elution fluid, such as acetone is added. The lid 48 is attached and the retaining vessel 46 is agitated so as to completely dissolve first filter 24, if present, and any dissolvable extraneous collected material. The vapor-tight retaining vessel 46, and filter sections, is then centrifuged (i.e. 3000 g for 2-3 min) so that material is passed through the second filter 28 and the third filter 44 semi-tangentially. After initial centrifugation, the unit is opened in a fume hood, flow through is discarded, additional solvent is added to the first sample material section 12 and agitated to wash upper chamber walls and retained material. The unit is reassembled and centrifuged again. This wash procedure is repeated for a total of three rinses as Applicant has found this to be best procedure although not mandatory. The filter sections are then removed from the retaining vessel 46 and held briefly over a vacuum source to draw any remaining solvent through to the bottom of the device. The third filter 44, the lower filter, is then removed for subsequent standard gDNA extraction (i.e. bead beating, MoBio) and PCR/dual-labeled probes detection methods.

Applicability of the complete protocol, including detection of pathogens by means of molecular probes, has been tested using inactivated Cryptosporidium parvum and Giardia intestinalis standard cyst preparations (Waterborne Inc., New Orleans, La). Detection limits of 2.5 cysts per liter of water from a 40 L sample of potable water have been achieved. A detection limit of 20 cysts per Liter in 5 L of environmental water with a turbidity of 3.8 NTU has also been achieved. Increases in sensitivity beyond these data are possible.

The description of the present embodiments of the invention has been presented for purposes of illustration, but is not intended to be exhaustive or to limit the invention to the form disclosed. Many modifications and variations will be apparent to those of ordinary skill in the art. As such, while the present invention has been disclosed in connection with an embodiment thereof, it should be understood that other embodiments may fall within the spirit and scope of the invention as defined by the following claims.

What is claimed is:

1. A filter apparatus comprising:
a. a first sample material section;
b. a second filter section, with a second filter, connected with said first sample material section;
c. a third filter section, with a third filter, connected with said second filter section;
d. a retaining vessel within which said first sample material section, said second filter section and said third filter section fit; and
e. a lid conformed to connect with said retaining vessel such that said lid seals said retaining vessel when connected.

2. The apparatus of claim 1 wherein said lid is a double sealing lid conformed to connect with said first sample material section and said retaining vessel.

3. The apparatus of claim 1 further including a first filter for holding sample material in said first sample material section.

4. The apparatus of claim 3 wherein said first filter is a one time use dissolvable filter.

5. The apparatus of claim 1 wherein said second filter is one size of filter and said third filter is another size of filter.

6. The apparatus of claim 1 wherein said second filter is a larger size of filter than said third filter.

7. The apparatus of claim 1 wherein said retaining vessel includes an interior support.

8. The apparatus of claim 7 wherein said third filter section rests on and is supported by said interior support.

9. The apparatus of claim 1 wherein said retaining vessel includes a collection basin.

10. A cyst filter apparatus comprising:
a. a tapered first sample material section;
b. a second filter section, with a second filter of one size, connected with said first sample material section;
c. a third filter section, with a third filter of a size different than said second filter, connected with said second filter section;
d. a retaining vessel within which said first sample material section, said second filter section and said third filter section fit; and
e. a lid conformed to connect with said retaining vessel such that said lid seals said retaining vessel when connected.

11. The apparatus of claim 10 further including a one time use dissolvable first filter for holding sample material in said first sample material section wherein said one time use dissolvable first filter is selected from a group of filters consisting of: flat and cylindrical.

12. The apparatus of claim 10 wherein said second filter is a larger size of filter than said third filter.

13. The apparatus of claim 10 wherein said retaining vessel includes an interior support.

14. The apparatus of claim 13 wherein said third filter section rests on and is supported by said interior support.

15. The apparatus of claim 10 wherein said lid is a double sealing lid conformed to connect with said first sample material section and said retaining vessel.

16. A filter method comprising:
a. collecting a sample;
b. providing a first sample material section, a second filter section, with a second filter, connected with said first sample material section, a third filter section, with a third filter, connected with said second filter section, a retaining vessel within which said first sample material section, said second filter section and said third filter section fit and a lid conformed to connect with said retaining vessel such that said lid seals said retaining vessel when connected;
c. placing the sample in said first sample material section;
d. placing said first sample material section, said second filter section and said third filter section in said retaining vessel;
e. adding elution fluid to said sample; and
f. connecting said lid with said retaining vessel.

17. The method of claim 16 further including the step of agitating said retaining vessel after connecting said lid with said retaining vessel.

18. The method of claim 17 further including the step of placing said retaining vessel in a centrifuge after agitating said retaining vessel.

19. The method of claim 16 wherein the step of placing a sample in said first sample material section includes locating sample material on a dissolvable first filter in said first sample material section.

20. The method of claim 16 further including adjusting sizes of said second filter and said third filter so as to trap various sizes of material from said sample.
